(19) United States
(12) Patent Application Publication
(10) Pub. No.: US 2007/0289754 A1
(43) Pub. Date: Dec. 20, 2007

(54) Lawn aerating vehicle

(76) Inventor: James O. Matthews, King, NC (US)

Correspondence Address: LITMAN LAW OFFICES, LTD., P.O. BOX 15035, CRYSTAL CITY STATION, ARLINGTON, VA, 22215, US

(21) Appl. No.: 11/727,347

(22) Filed: Mar. 26, 2007

Related U.S. Application Data
(60) Provisional application No. 60/813,709, filed on Jun. 15, 2006.

(51) Int. Cl. A01B 45/02

(52) U.S. Cl. 172/21; 172/280; 172/4; 172/828

(57) ABSTRACT

The lawn aerating vehicle has front and rear steering sections, each of which supports an aerator drum. Each drum has multiple cutting tines extending radially outward for soil penetration during the aerating process. A hydraulic motor and a belt or chain drive connected to the front drum propel the vehicle. Steering actuators provide pivotal torque to the drums for steering. A hydraulic pump and reservoir provide hydraulic power to the hydraulic motor and actuators. A cylindrical member forms part of a vehicle suspension by connecting the rear and front steering sections. Frame members and an operator's cab are disposed above the suspension and can be pivoted around the cylindrical member to provide cab leveling by means of a cab leveling actuator. The two drums provide for double coverage per pass. External vehicle lights permit operation during nighttime and otherwise poor visibility conditions.

### CROSS-REFERENCE TO RELATED APPLICATION

This application claims the benefit of U.S. Provisional Patent Application Ser. No. 60/813,709, filed Jun. 15, 2006.

### BACKGROUND OF THE INVENTION

1. Field of the Invention

The present invention relates to landscaping machines, and more particularly, to a lawn aerating vehicle for aerating a lawn.

2. Description of the Related Art

The soil in residential lawns frequently becomes compacted, leading to poor drainage. The lack of water adversely impacts the quality of the grass, resulting in poor lawn appearance. In order to correct this problem, it is necessary to periodically aerate the lawn. Manual lawn aerators take a great deal of time and effort, particularly if the lawn has a lot of square footage. Lawn aerating attachments for lawn tractors are typically small and rigid, requiring multiple passes over flat terrain and being difficult to operate properly over hilly terrain. Consequently, there is a need for a lawn aerating vehicle that is efficient to operate over flat terrain and that is safe, comfortable, and easy to operate over hilly terrain.

Thus, a lawn aerating vehicle solving the aforementioned problems is desired.

### SUMMARY OF THE INVENTION

The lawn aerating vehicle is a self-propelled vehicle having front and rear steering sections, each of which supports an aerator drum. Each drum has multiple cutting tines extending radially for lawn penetration. A hydraulic motor and a belt or chain drive connected to the front drum propel the vehicle. Steering actuators provide pivotal torque to the drums for steering. A hydraulic pump and reservoir provide hydraulic power to the hydraulic motor and actuators.

A cylindrical member forms a part of the vehicle suspension by connecting the rear and front steering sections. Frame members and an operator's cab are disposed above the suspension and can be pivoted around the cylindrical member to provide cab leveling by means of a cab leveling actuator. Pivoting around the cylindrical member provides the capability of operation over uneven terrain without binding the vehicle. The cab leveling actuator provides approximately ±45° leveling rotation of the cab. Thus, the aerator is designed to allow the operator to ride with confidence over varied and hilly terrain while aerating the lawn. Moreover, the two aerating drums provide for double coverage per pass. External vehicle lights permit operation during nighttime and otherwise poor visibility conditions. A canopy over the seat provides weather protection to the operator.

These and other features of the present invention will become readily apparent upon further review of the following specification and drawings.

### BRIEF DESCRIPTION OF THE DRAWINGS

FIG. 1 is a perspective view of a lawn aerating vehicle according to the present invention.

FIG. 2 is a top plan view of the lawn aerating vehicle according to the present invention.

FIG. 3 is a side view of the lawn aerating vehicle according to the present invention.

FIG. 4 is a rear view of the lawn aerating vehicle according to the present invention.

Similar reference characters denote corresponding features consistently throughout the attached drawings.

### DETAILED DESCRIPTION OF THE PREFERRED EMBODIMENT

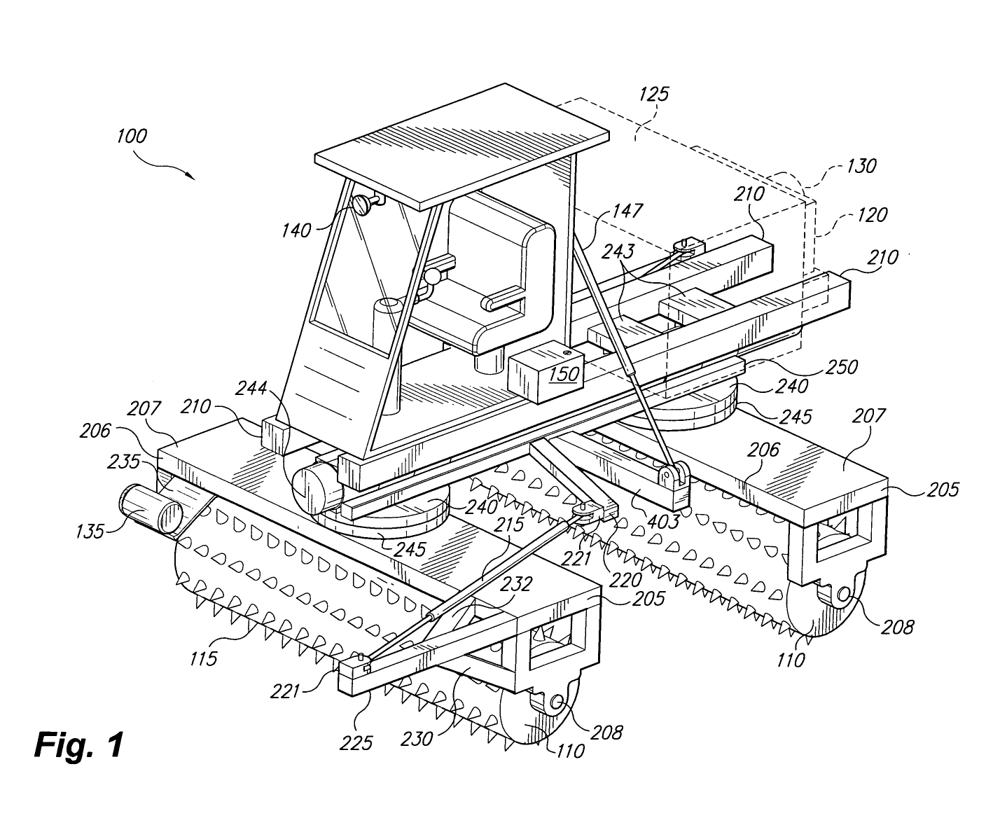

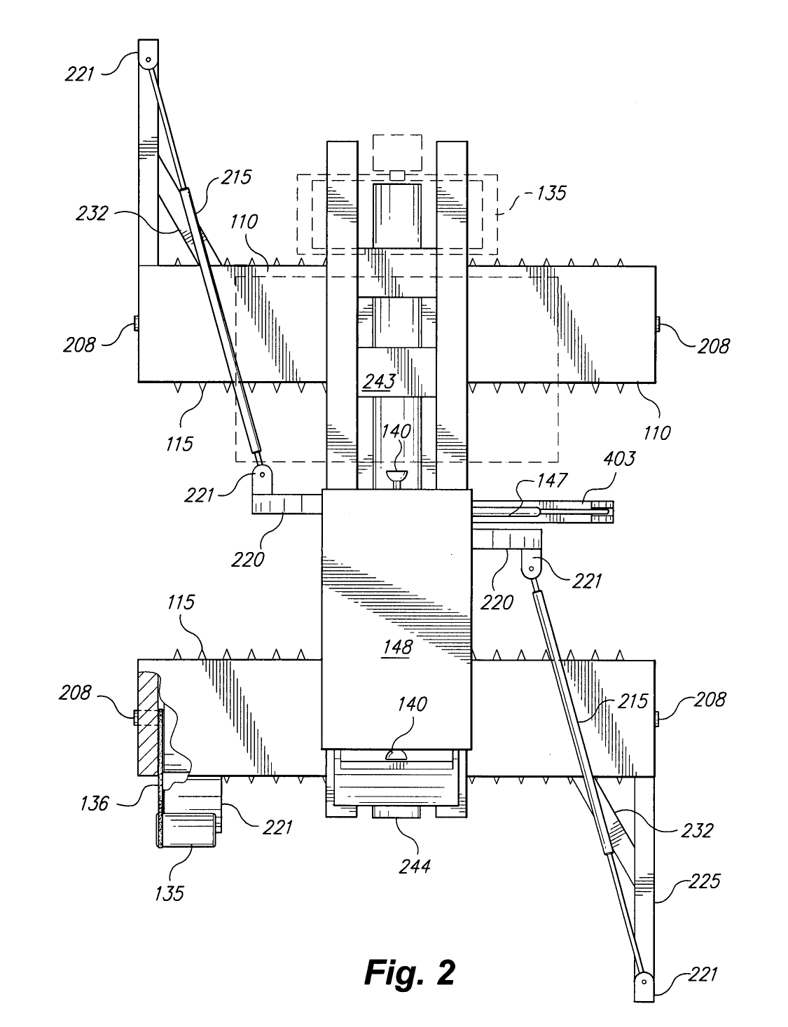

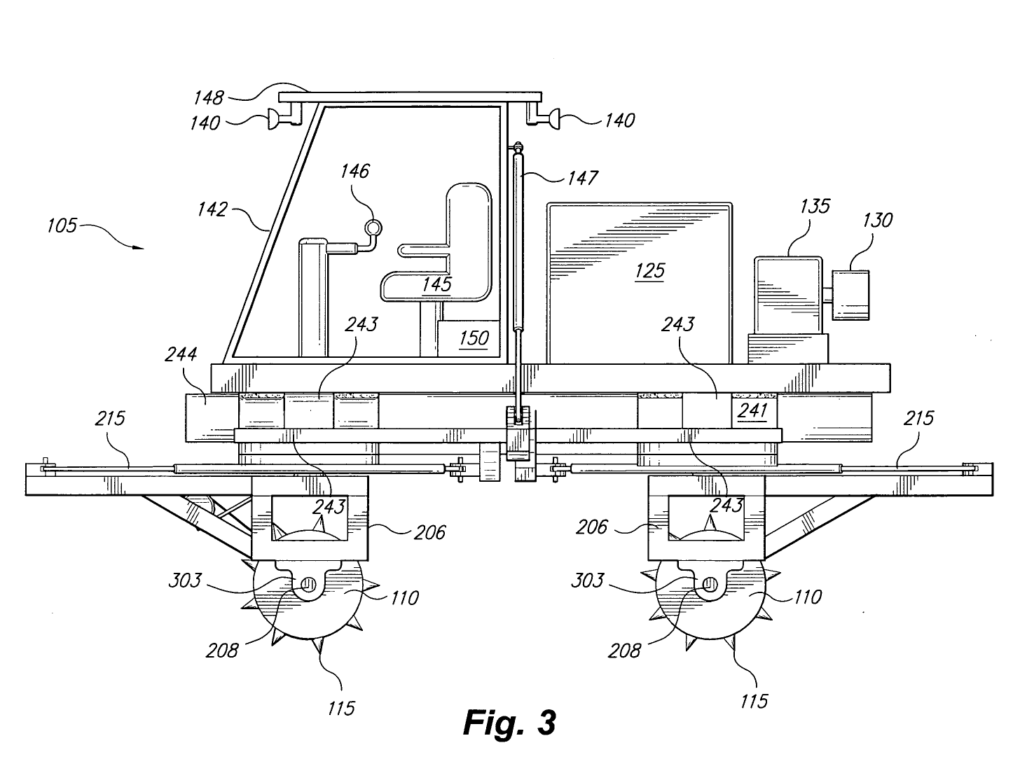

As shown in FIGS. 1-4, the present invention is a lawn aerating vehicle 100 having a rear steering section and a front steering section, each of which has a bearing on the bottom of each lateral side to hold the ends of rear and front aerator drums 110 in place, respectively. Each drum 110 has a plurality of radially extending cutting tines 115 disposed laterally across the aerator drum 110 in a predetermined pattern. As shown in FIG. 3, spikes, i.e., cutting tines 115, are arranged at 40° intervals around the circumference of the drum 110. The 40° intervals shown in FIG. 3 are exemplary, and it will be understood that the angular spacing between the tines may be greater or less than 40°.

Each aerator drum 110 is supported by an aerator drum frame 207. The aerator drum frame 207 comprises a plurality of longitudinal frame members 205 and a plurality of lateral frame members 206, which are interconnected to form the rectangular shaped drum frame 207. Bearing housings 303 are disposed at opposing lateral ends of the drum frame 207 to provide support of drum axles 208.

A hydraulic motor 135 is attached to a motor support 235 at a lateral end of the drum frame 207. The hydraulic motor 135 is connected via a belt or drive chain 136 to the front drum 110 for propelling the machine forward or backward. A hydraulic pump 130, engine 120 and reservoir 125 stationed toward the rear of the vehicle provide hydraulic steering power, as well as locomotion power, to the hydraulic motor 135 (pump 130, engine 120, reservoir 125, and/or motor 125 are shown in phantom in FIGS. 1, 2 and 4 in order to show other details of the vehicle 100).

Each aerator drum 110 pivots about a central longitudinal axis of the vehicle 100 to provide independent front and rear drum steering. Steering is accomplished by hydraulic steering actuators 215, which provide pivotal torque to the aerator drums 110.

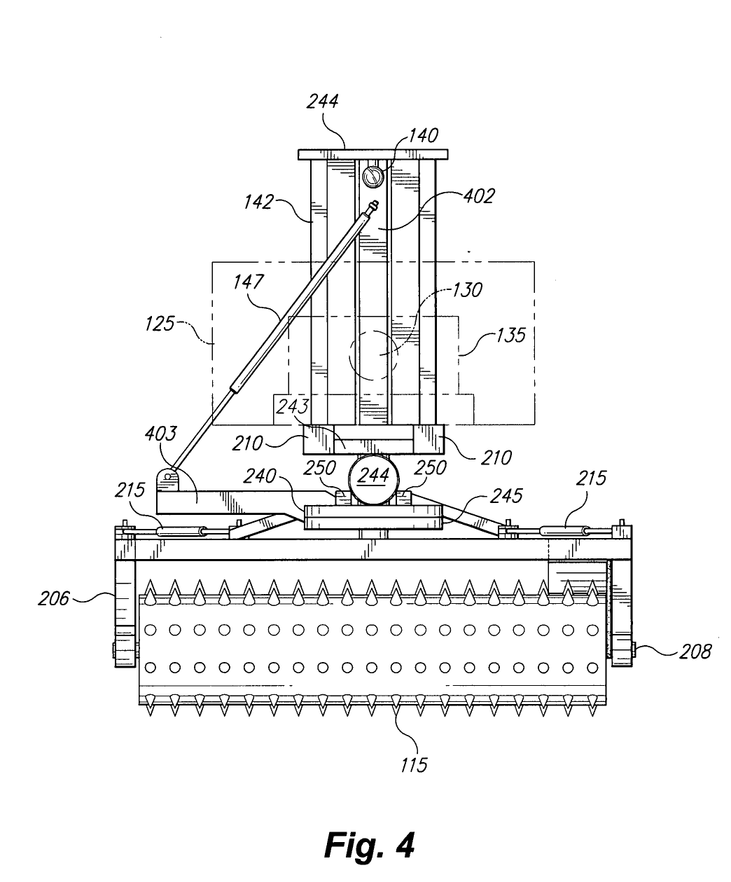

As shown in FIG. 4, the drums 110 are attached to lower rotatable disc-shaped plates, the lower plates 245 having a loose coupling to upper stationary disc-shaped plates 240, which have an interconnection under the vehicle 100. The loose coupling of the lower plates 245 to the upper plates 240 comprises a nut and bolt fitting that allows rotation of the lower plate 245 under the stationary upper plate 240. The interconnection of the front and rear stationary disc-shaped plates 240 is a longitudinal interconnection, which is achieved by attachment of stationary attachment disk bushings 241 extending from the disc 240 to a cylindrical support member 244 that extends along the longitudinal axis of the vehicle 100, as shown in FIG. 3.

The loosely-coupled disc-shaped plates have grease or other suitable lubrication between their surfaces to reduce friction so that the lower 245 and upper 240 disc plates may function as a bearing to provide rotational motion of the drums 110 in response to torque input from the hydraulic actuators 215.

Referring to FIG. 4, left and right side rail suspension members 250 are attached longitudinally to the cylindrical support member 244. The side rail suspension members 250 provide additional support and attachment points for components of the vehicle 100. Also, longitudinally extending cylindrical support member 244 is split proximate to a midpoint of the vehicle length in order to provide independent pivotal motion of front and rear steering sections so that drums 110 can operate over twisty, bumpy, hilly terrain, and the like, without binding the vehicle. Alternatively, for each side of the vehicle 100, cylindrical support member 244 is pivotally joined by a pin at end points of the vehicle to achieve the independent pivotal motion of the front and rear steering sections.

The body of steering actuator 215 is pivotally connected to a central portion of the vehicle undercarriage, preferably at a lateral end of a steering actuator support bracket 220, which is attached to side rail 250. The arm of actuator 215 is pivotally connected to a steering member 225 by a pivot connector 221, the steering member 225 being attached to, and extending longitudinally from, a lateral end of the drum frame 207. Also, a first steering member brace 230 extends transversely from the drum frame 207 and is attached to the steering member 225. A second steering member brace 232 extends from a bottom portion of the drum frame 207 in the same vertical plane as the steering member 225 and joins the steering member 225 approximately midway of the length of the steering member 225. Actuator arm movement is controlled by the operator and provides the required steering torque to steer the vehicle 100 according to user-commanded hydraulic inputs. Side rail suspension members 250 and stationary disks 240 have grease/lubrication fittings to obviate wear and tear of pivoting and rotation associated with those components when the vehicle 100 is in operation.

A cab 142 having a seat 145 for the operator and control valves 146 for steering and cab leveling is centrally disposed on the vehicle above the cylindrical support member 244. Cab 142 may have seatbelt and side panel doors to secure the operator in the vehicle 100 during operations. A fuel tank 150 is disposed to the side of the seat 145. Pivotal attachment of the cab 142 and carriage, i.e., longitudinal support members 210, is achieved through cab undercarriage bushings 243, which permit rotational movement of the cab 142 and carriage members 210 about the cylindrical support member 244. Side rail suspension members, i.e., members 250, have grease/lubrication fittings to obviate wear and tear of pivoting and rotation associated with those components when the vehicle 100 is in operation.

A cab leveling hydraulic actuator 147 is included to keep the operator upright and level during operations over hilly terrain. An actuator arm of the cab leveling actuator 147 is attached to a leveling cylinder support member 403 that extends laterally from side rail suspension members 250 under the cylindrical support member 244.

An arm of the cab leveling actuator 147 is pivotally attached to a laterally outboard upper rear section, preferably at a cab vertical support member 402 of the cab 142, so that a longitudinal axis of the cab leveling actuator is approximately at a 45° angle from a lateral plane defined by the left and right side rail suspension members 250. The cab leveling actuator 147 provides approximately ±45° leveling rotation of the cab 142 about the central median axis of the vehicle by means of rotation around the cylindrical support member 244.

Thus, the aerator vehicle 100 provides the operator the capability to ride with confidence over varied and hilly terrain while aerating the lawn. Moreover, the two aerating drums 110 provide for double coverage for each pass over a section of lawn. Lights 140 disposed externally on the cab 142 allow the aerator vehicle 100 to be used in nighttime and otherwise poor visibility conditions. A canopy 148 over the seat 145 protects the operator from the weather.

It is to be understood that the present invention is not limited to the embodiment described above, but encompasses any and all embodiments within the scope of the following claims.

I claim:

1. A lawn aerating vehicle, comprising:
front and rear steering sections;
a rear aerator drum supported by the rear steering section;
a front aerator drum supported by the front steering section, the front and rear aerator drums having multiple cutting tines extending radially outward to provide soil penetration during aeration of a lawn;
a motor;
a drive connecting the motor to one of the drums to propel the vehicle;
steering actuators connected to the front and rear steering sections to provide pivotal torque to the drums for steering the vehicle;
a cab having an active undercarriage mounted above the steering sections to provide operator-controlled cab leveling;
propulsion, steering and leveling controls disposed in the cab for operator use;
external lights mounted on the cab to provide operability during poor visibility conditions; and
a canopy disposed over the seat to provide weather protection for the operator.

2. The lawn aerating vehicle according to claim 1, further comprising:
a bearing disposed on each lateral side of the front and rear steering sections the rear and front aerator drums being rotatably mounted in the bearings.

3. The lawn aerating vehicle according to claim 1, wherein said cutting tines are arranged at 40° intervals around the circumference of each said drum.

4. The lawn aerating vehicle according to claim 1, wherein the motor is a hydraulic motor.

5. The lawn aerating vehicle according to claim 1, wherein the steering actuators are hydraulic actuators.

6. The lawn aerating vehicle according to claim 1, further comprising:
a hydraulic pump connected to an engine and a reservoir, the pump, engine and reservoir being disposed behind the cab, the pump, engine and reservoir providing hydraulic steering power to the actuators and locomotive power to the motor.

7. The lawn aerating vehicle according to claim 1, wherein the steering controls are configured to provide independent front and rear drum steering.

8. The lawn aerating vehicle according to claim 1, wherein the steering sections further comprise:
lower rotatable disc-shaped plates, the drums being attached to the lower rotatable disc-shaped plates; and
upper stationary disc-shaped plates; and
a pivot pin, the lower disc-shaped plate being pivotally attached to the upper disc-shaped pin by the pivot pin for rotation about the pivot pin for steering of the drum.

9. The lawn aerating vehicle according to claim 8, wherein the disc shaped plates are lubricated between the plates to reduce friction so that the lower and upper disc plates may function as a bearing to provide rotational motion of the drums in response to torque input from the hydraulic actuator.

10. The lawn aerating vehicle according to claim 1, wherein the active undercarriage is split between a rear section and a forward section in order to provide independent pivotal motion of front and rear steering sections to facilitate vehicle operation over twisty, bumpy, hilly terrain.

11. The lawn aerating vehicle according to claim 1, wherein said undercarriage comprises:
side rail suspension members attached to said front and rear steering sections;
a leveling cylinder support member laterally extending from the side rail suspension members; and
a cab leveling actuator having an actuator arm attached to the leveling cylinder support member and an opposite end attached to the cab, the side rail suspension members being disposed under the cylindrical support member;
wherein a longitudinal axis of the cab leveling actuator is approximately at a 45° angle from a lateral plane defined by the side rail suspension members so that approximately ±45° leveling rotation of the cab is provided about a central median axis of the vehicle by means of rotation around the cylindrical support member.
